(19) United States
(12) Patent Application Publication
(10) Pub. No.: US 2011/0173133 A1
(43) Pub. Date: Jul. 14, 2011

(54) SECURITIES DATA ANALYSIS AND PREDICTION TOOL

(76) Inventor: AUGUSTINE ADEBAYO OJO, TORONTO (CA)

(21) Appl. No.: 12/685,395

(22) Filed: Jan. 11, 2010

(51) Int. Cl. G06Q 40/00

(52) U.S. Cl. 705/36 R

(57) ABSTRACT

A system and method for data analysis and presentation of securities such as stocks, futures, options, forex, and bonds that uses information from both historical and presents signals relating to the security to predict short term, intermediate and long-term future directions of the security to help position the traders on the right-side of the market by converting the gathered information to primary signals. The system also leverages secondary information sources and/or signals such as increased/decreased volume of buyers/sellers, buy/sell trend direction, changing accumulation/distribution pressure, and oscillating frequency to present exhaustive information related to the security and further to display such information along with primary information in a single-page view so as to enable an analyst/investor to make a basic buy/sell decision in a timely and informed fashion.

### FIELD OF THE INVENTION

The present invention relates generally to selectively gathering, analyzing and presenting data of securities such as stocks, options, futures, bonds and forex and more specifically to a system and method of using the securities data and other current trends related to the security to predict a future direction of the security.

### BACKGROUND OF THE INVENTION

Conventionally, the security trading business with stock trading business in particular, has been speculative in nature and to aid the investors make informed decisions, various stock market forecasting and analysis tools have been in use. These tools have traditionally been based on historical stock information, including historical stock prices and stock sales history. Analysis of such tools is presented in a graphical format typically represented as a price versus time display. It is then left to an analyst's/investor's subjective interpretation to analyze the information and make decisions. More often than not, such an interpretation is marred by personal biases, feelings, hunches, opinions of stock trading firms, market “noises” and is further limited by the analyst's/investor's individual capability to interpret the complex information which is often conflicting and misleading. Coupled with a lack of simultaneous access to comprehensive information sources, it might put the analyst/investor at risk to the fluctuating market rates. Moreover, because the available tools, at best, update the stock information in a 1-3 minute interval, by the time a decision is made, the stock price rates can go through a drastic change, making the whole exercise of utilizing such tools futile.

The current available tools not only require prior trading knowledge but are also restrictive in the manner in which they offer a limited number of display options making the analyst and/or the investor toggle between the various displays to arrive at an informed decision.

On many occasions, secondary information and/or signals such as increased/decreased volume of buyers/sellers, changing accumulation/distribution pressure, buy/sell trend, and oscillating frequency play a key role in arriving at decisions relating to stock trading. Lack of such information in a timely, concise, single-page format with other key information puts the onus on the analyst/investor to peruse all such secondary information and come to a final conclusion. This not only creates an avoidable pressure on the analyst/investor to check multiple displays, but also generates a time lag in arriving at a conclusion, thereby defeating the entire purpose of employing a stock trading tool.

Therefore, there is a need to develop an agile and smooth data analysis and display tool that analyzes and presents both historical and current security data in a near real-time manner while taking into consideration secondary sources of information among other sensitive data such as moving averages, oscillators, and trend finders to project future trends based on a desired time frame from minute data to yearly data. Such future trend prediction should not only be done for stocks, but should rather also be enabled for options and forex among other securities. Further, such a tool should display the trends in a single-view format so as to enable the analyst and/or investor make informed objective decisions without unnecessarily toggling between multiple pages.

### SUMMARY OF THE INVENTION

The present invention provides a system and method for data analysis and presentation of securities such as stocks, futures, options, and bonds that uses information from both historical and present signals relating to a security to present primary information and predict short term, intermediate and long-term future directions and/or trends of the security and help position the traders on the right-side of the market. The system of the present invention also leverages secondary information sources and/or signals such as increased/decreased volume of buyers/sellers, also commonly referred to as accumulation/distribution pressure sensors, buy/sell trend direction, and oscillating frequency to present exhaustive information related to the security and further to display such information along with the primary information in a single-page view so as to enable an analyst/investor to make a basic buy/sell decision in a timely and informed fashion. The present invention further provides dynamic and automatic support and resistance levels, reversal targets, potential target price, stop loss levels, prevailing current trend, risks involved in trade, among other meaningful information in an easy to interpret manner through the tool.

### BRIEF DESCRIPTION OF THE DRAWINGS

The embodiments herein will be better understood from the following detailed description with reference to the drawings, in which:

FIG. 1 illustrates an analytic view of the trend structure of primary signals, in accordance with one embodiment of the present invention;

FIG. 2 illustrates an analytic view of the trend structure of primary signals, secondary signals, and confirmatory supporting information in accordance with another embodiment of the present invention; and

FIG. 3 illustrates an analytic view of the trend structure of multiple resistant and support levels, in accordance with still another embodiment of the present invention.

### DETAILED DESCRIPTION OF THE INVENTION

In accordance with the general teachings of the present invention, systems and methods described herein use time based historical price information and other indicators to develop a comprehensive understanding of the idiosyncratic nature of a security such as a stock, its movement and price patterns to predict the directional position of the security to generate buy/sell signals for an immediate, short, intermediate and long term. The systems and methods further accumulate stock data from varied sources and work on time frames ranging from minute data to yearly data to identify sell/buy behaviors along with current prevailing trend, identify reversals, and further identify support and resistant levels. This integration of data availability and time ranges makes the system for stock data analysis and prediction robust and ensures an exhaustive, error bounded information gateway to the analyst/investor operating this system. In another aspect of the present invention, the system also includes and analyzes data from multiple secondary sources such as increased/decreased volume of buyers/sellers, buy/sell trend, and oscillating frequency to strengthen the proposed recommendation/indication. Such data collected and analyzed by the system is presented to the analyst and/or the investor in a display format that is both convenient and easy to interpret.

It is to be noted that even though the description of the invention has been explained using stocks, it should, in no manner, be construed to limit the scope of the invention. The systems and methods of the invention can apply to any security including, but not limited to a stock, forex, future, and/or option, among other securities.

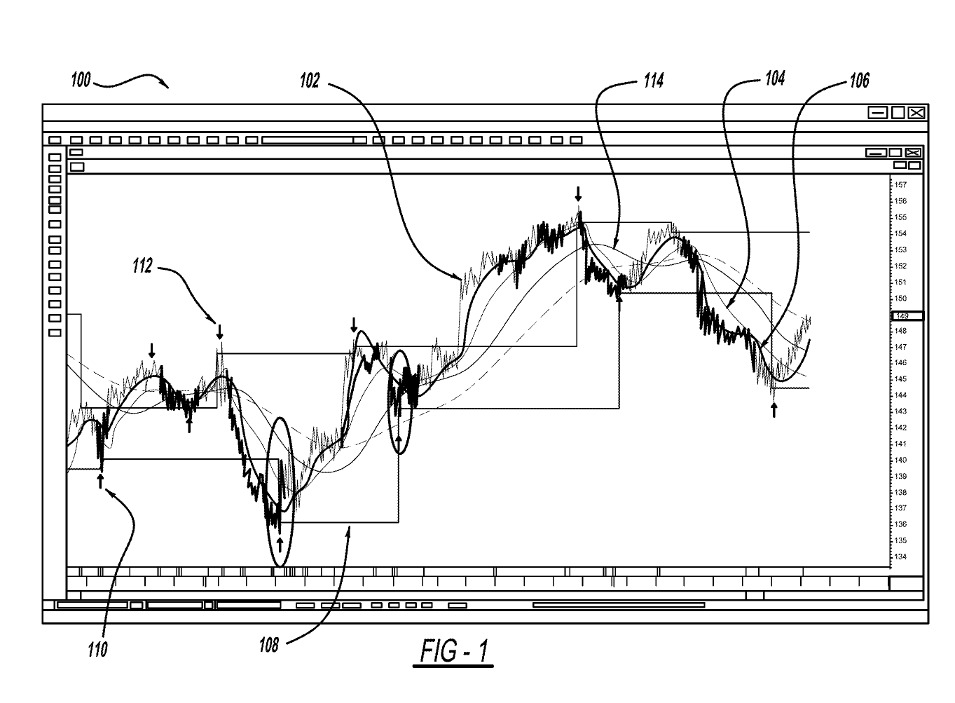

FIG. 1 illustrates an analytic view 100 of the trend structure of primary signals to predict the market behavior.

In this embodiment, the analytic view 100 presents the trend structure of the primary signals giving indications of the variations in a stock from the viewpoint of one or more attributes. The signals can be drawn and interpreted for multiple timeframes and for investors having day trading, swing, intermediate, or long-term view of the market/stock. The analytic view 100 is presented based on historical and time-based data of the stock received by the system from varied sources.

In an embodiment, once the system receives and presents historical and time-based stock data, the system uses the analytic view 100 as a springboard and predicts the next direction of the stock based on the analytic view 100. The system can predict the next direction and/or behavior of the stock at every timeframe and generate a robust buy/sell signal to give the investor/analyst a clear indication of the recommendation. The system therefore enables quick and robust prediction of each stock so as to predict the trend in real-time and recommend the analysis within an acceptable timeframe.

By way of a non-limiting example, the analytic view 100 indicates trends derived from primary data sources. The analytic view 100 indicates candle sticks 102, moving average (MA) crossover trend 104, close price bar 106, and resistant and support lines 108. In another embodiment, the analytic view 100 also demonstrates the buy signal triggers 110 and sell signal triggers 112 for the particular stock.

By way of another non-limiting example, the analytic view 100 can also be configured to present open price bars, high price bars, low price bars similar to the close price bar 106. In an embodiment, it can be noticed in the analytic view 100 that the support is triggered when the stock price is 137.50 as demonstrated by the support line 108. The upward arrows and/or the buy signal triggers 110 demonstrate such support line 108 and indicate a buy signal to the investor and/or analyst at the stock price levels of 137.50. The investor therefore would go “Long” in such a scenario as the analytic view 100 demonstrates high resistance and support at such stock price levels of 137.50.

The analytic view 100 can still be further configured to present multiple resistant and support levels, wherein each such resistant and support level is triggered based on the strength of resistance and support provided at that level. For instance, the resistant and support levels can be divided into three tiers: minor, major and mega resistant and support levels (RS level). The major RS level, for instance, has high strength and in case the stock/security reaches the major RS level, it would have high probability of automatically self-triggering than when the RS level reaches the minor RS level. Such tier based RS level presentation can therefore allow dynamic and automatic nature and interpretation of the stock trend. Additionally, the MS crossover trend 104 can also be configured to change automatically and dynamically to be highly responsive to the changing market conditions.

By way of still another non-limiting example, the analytic view 100 can recommend a long and/or short opinion based on the resistance and support lines 102, price trends such as demonstrated by close price bar 106, MA crossover trend 104 and/or other primary signal indicators. Further, primary signal indicators such as candle sticks 102 can also be color coded to indicate trend continuations or reversals for easy interpretation. A black candle stick, for instance, can indicate a positive/buy trend for easy interpretation of the analyst and/or investor. The system can also be configured to give a final indication to the investor/analyst as to buy or sell the stock based on one or more of the candle sticks 102, the MA crossover trend 104, the close price bar trend 106, the support line 108, and the buy signal triggers 110. For example, in case any three of the above five primary signal indicators indicate a positive opinion in analytic view 100, a buy signal can be recommended by the system. For instance, in case the candlestick 102 is black, the support line 108 is triggered, and the MA crossover trend 104 is above the wiggly line 114, a buy recommendation can be given to the analyst/investor.

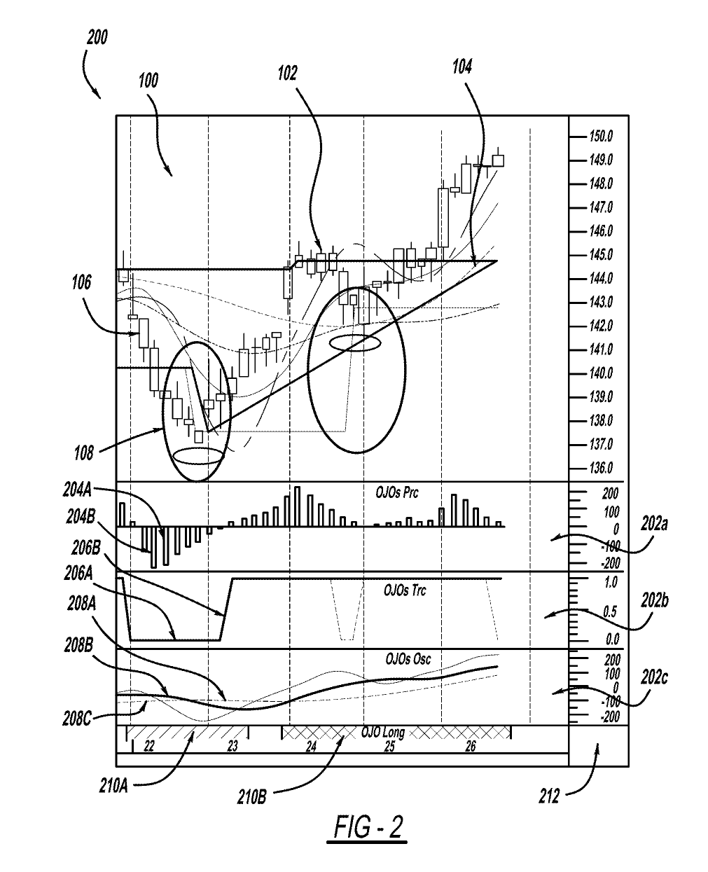

FIG. 2 illustrates an analytic view 200 of the trend structure of primary signals, secondary signals, and confirmatory supporting information to predict market behavior.

In this embodiment, the historical data shown in the analytic view 200 demonstrates the primary signals as shown in the analytic view 100, secondary signals 202(A), 202(B), and 202(C), hereinafter collectively referred to as secondary signals 202. The analytic view 200 also demonstrates confirmatory supporting information 210 (A) and 210 (B), hereinafter collectively referred to as supporting information 210. The historical data is received by the system from varied sources along a defined timeline. For instance, the analytic view 200 is presented and analyzed from the 22nd day of a month to the 26th day of the month and prediction of the stock is done for the 27th day of the month based on the primary signals shown in analytic view 100, secondary signals 202, and further based on the supporting information 210.

By way of a non-limiting example, the secondary signals 202 include buying/selling pressure signals 202(A), the trend finder signals 202(B), and oscillator speed signals 202(C). The buying/selling pressure signals 202(A), also commonly referred to as volume oscillator signals or bulls/bears pressure signals or accumulation/distribution pressure signals, demonstrate the change in volume of buyers and sellers involved in daily trading of the stock, represented by buyers magnitude 204(A) and sellers magnitude 204(B). For instance, the buyer magnitude 204(A) decreases between the 22nd and 23rd of the month as the share/stock price came down; and increased between the 23rd and 24th as the share/stock price tested the support level 108 allowing the investors to enter the market at a higher-low share/stock price (i.e., a price that is still low but higher than the last lowest price). The buying/selling pressure signals 202(A) can also demonstrate the bias and/or sentiment of the buyers and the sellers about a particular security such as stock. The demonstrated bias of the buyers and the sellers can either reflect the desire of the investors to accumulate more of the same security or dispose off the existing holdings. The buying/selling pressure signals 202(A) can demonstrate the bearish and/or bullish behavior through change in signal color. For instance, the bulls/bears pressure signals 202(A) color (or other indicia) can change from dark grey to light grey when the price of the security is falling due to bullish pressure.

By way of another non-limiting example, the trend finder signals 202(B) demonstrate change from a buy signal to a sell signal. The trend finder signal 202(B) hovers between 0 and 1 wherein a change from 0 to 1, as depicted by 206(A), indicates a buy signal and a change from 1 to 0, as depicted by 206(B), indicates a sell or take profit signal. For instance, the trend finder signals 202(B) demonstrates a change from 206(A) to 206(B) at around the 23rd of the month, when the stock price is testing the support levels and therefore expected to rise from those levels of 137.50. Once the stock price increases to the levels of 142.00, the trend finder signals 202(B) would demonstrate a change from 206(B) to 206(A), during which period the investors would sell and take profit from the stock.

By way of still another non-limiting example, the oscillator speed signals 202(C) indicate information on the direction and speed of changes. The oscillator speed signals 202(C) include signal 208(A) demonstrating fast speed for prediction during day and swing trading, signal 208(B) demonstrating medium speed for prediction during swing to intermediate trading, and signal 208(C) demonstrating slow speed for prediction during intermediate to long term trading. Crossing of the signal 208(A) over the signal 208(B) would demonstrate the stock to be preferred and recommended for day trade rather than for a long-term trade.

The supporting information 210 can include a “Short” indicator 210(A) and a “Long” indicator 210(B). The indicator 210(A) recommends selling the stock due to falling stock prices as is demonstrated between the 22nd and the 23rd of the month. The indicator 210 (B), on the other hand, recommends buying and/or holding the stock due to increasing/higher stock prices as is demonstrated between the 24th and the 26th of the month. The supporting information 210 can be represented as colored bars (or other indicia), the selling indicator 210 (A) by a red bar and the buying indicator 210 (B) with a green/blue bar (or other indicators).

Based on the primary signals indicated in the analytic view 100, the secondary signals 202, and the supporting information 210, a recommendation can then be given by the system through a simple interface and/or mechanism as demonstrated by the icon 212. For instance, an emoticon (or other indicia) can be used to indicate whether to buy or sell a specific stock.

The analytic view 200 of the system therefore combines analytic view 100, the secondary signals 202, and the supporting information 210 into a single visual sheet, thereby adding to the convenience of the analyst/investor, who is able to make an informed decision based on single page information. The system allows incorporation of multiple attributes by means of the primary and secondary signals and can decide in real-time as to the more reliable attribute(s) to be taken into consideration for specific stocks allowing more reliable prediction of the future movement of the stock.

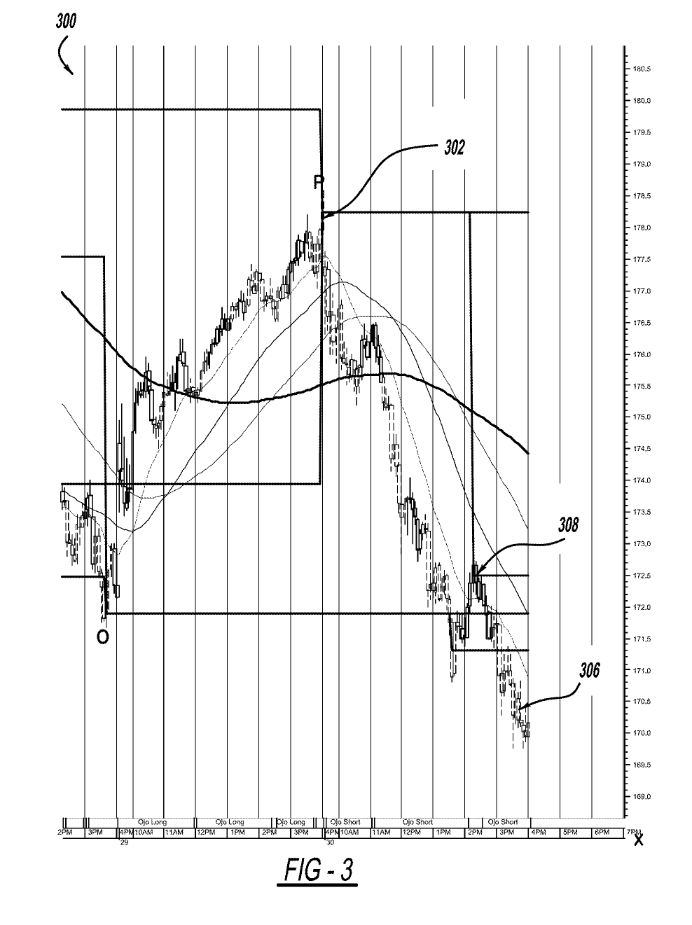

FIG. 3 illustrates an analytic view 300 of the trend structure of multiple resistant and support levels. Support is the price level at which demand is thought to be strong enough to prevent the price from declining further. By the time the price reaches the support level, it is believed that demand will overcome supply and prevent the price from falling below support. Resistance, on the other hand, is the price level at which selling is thought to be strong enough to prevent the price from rising further. By the time the price reaches the resistance level, it is believed that supply will overcome demand and prevent the price from rising above resistance.

In this embodiment, multiple support and resistance lines can be demonstrated by the analytic view 300 to enable the user to understand the previous trend of the concerned security and also to understand the magnitude of support and/or resistance provided by the security at each support level and resistance level. A major support level interpreted based in previous price trends, for instance, would indicate high probability that the security would not go below the major support level.

By way of a non-limiting example, price point 302 shows a major resistant level, triggered at around the 178.50 price point, and indicating a price level at which the supply overcomes the demand and the investors sell stocks to realize profits. Price point 304, on the other hand, shows a minor support level, triggered at around the 170.50 price point, and indicating a price level at which the demand overcomes the supply giving an opportunity to the investors to buy stocks taking a short position. Price point 304 however is a minor support level, as the buying at these levels is not heavy or the levels do not provide high strength at these levels. Price point 306, similarly shows a minor resistant level, triggered at around the 172.50 price point, and indicating a price level at which the supply overcame the demand for a short period even though the strength of such minor resistant level is low and no heavy selling happened at these levels.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A security data analysis and prediction system, comprising:
a storage means for collecting data of said security, wherein said data includes historical and present price information and/or other information relating to said security;
a display means for presenting said collected data of said security, wherein said presented data indicates primary signals including one or more of candle sticks, moving average crossover trends, close price bars, open price bars, high price bars, low price bars, reversal targets, potential target price, stop loss levels, degree of risk involved, and/or plurality of resistance and support lines; and
a processing means for predicting buy and sell signals for short, intermediate, and/or long term based on one or more signals selected from said primary signals, wherein said one or more signals are selected from said primary signals in real-time based on market indicators that accurately predict said security.

2. The security data analysis and prediction system as claimed in claim 1, wherein said security is one or more of a stock, an option, a future, a bond, and/or a forex.

3. The security data analysis and prediction system as claimed in claim 1, wherein said display means further indicates secondary signals including one or more of buying/selling pressure signals, trend finder signals, and/or oscillator speed signals.

4. The security data analysis and prediction system as claimed in claim 3, wherein said buying/selling pressure signals indicate change in volume of buyers and sellers in trading said security.

5. The security data analysis and prediction system as claimed in claim 3, wherein said trend finder signals indicate change from a buy signal to a sell signal, wherein said buy/sell trend signals are indicated in the range of 0 to 1.

6. The security data analysis and prediction system as claimed in claim 3, wherein said oscillator speed signals indicate information on direction and speed of changes of said security.

7. The security data analysis and prediction system as claimed in claim 6, wherein said speed of changes includes fast speed of change, medium speed of change, and/or slow speed of change.

8. The security data analysis and prediction system as claimed in claim 1, wherein each of said plurality of resistant and support lines indicates strength of resistance and support provided by said resistant and support lines at respective price levels.

9. The security data analysis and prediction system as claimed in claim 1, wherein said display means further indicates supporting information including a short indicator and/or a long indicator, wherein said short indicator indicates selling of said security and said long indicator indicates buying of said security.

10. The security data analysis and prediction system as claimed in claim 9, wherein said primary signals, said secondary signals, and/or said supporting information are presented in a single-page view format.

11. The security data analysis and prediction system as claimed in claim 1, wherein said display means further indicates a representation means depicting said prediction of said buy and sell signals for said short, intermediate, and/or long term.

12. A method for analyzing and predicting a security comprising:
collecting data of said security, wherein said data includes historical and present price information and/or other information relating to said security;
presenting said collected data of said security, wherein said presented data indicates primary signals and secondary signals, wherein said primary signals include one or more of candle sticks, moving average crossover trends, close price bars, open price bars, high price bars, low price bars, reversal targets, potential target price, stop loss levels, degree of risk involved, and/or a plurality of resistant and support lines, and said secondary signals include one or more of buying/selling pressure signals, trend finder signals, and/or oscillatory speed signals;
predicting buy and sell signals for short, intermediate, and/or long term based on one or more signals selected from said primary signals and said secondary signals, wherein said one or more signals are selected from said primary signals and said secondary signals in real-time based on market indicators that accurately predict said security.

13. The method as claimed in claim 12, wherein said display means further indicates supporting information including a short indicator and/or a long indicator, wherein said short indicator indicates selling of said security and said long indicator indicates buying of said security.

14. The method as claimed in claim 13, wherein said primary signals, said secondary signals, and/or said supporting information are presented in a single-page view format.

15. The method as claimed in claim 12, wherein each of said plurality of resistant and support lines indicate strength of resistance and support provided by said resistant and support lines at respective price levels.

16. The method as claimed in claim 12, wherein said buying/selling pressure signals separately indicate and interpret increase/decrease in accumulation pressure and distribution pressure for said security.

17. The method as claimed in claim 12, further comprising indicating exit points, profit taking points, and/or entry/re-entry points.

18. The method as claimed in claim 12, further comprising displaying said predicted buy and sell signals through a representation means such as a logo, picture, symbol, mark, and/or a character.

19. The method as claimed in claim 12, wherein each of said primary signals and said secondary signals is color coded for easy interpretation by investor and/or analyst.

20. The method as claimed in claim 12, wherein said primary signals include buy and/or sell signal triggers.
